(19) United States
(12) Patent Application Publication
(10) Pub. No.: US 2026/0031495 A1
(43) Pub. Date: Jan. 29, 2026

(54) SECONDARY BATTERY AND METHOD OF MANUFACTURING SAME

(71) Applicant: SAMSUNG SDI CO., LTD., Yongin-si (KR)

(72) Inventors: Eun Sung LEE, Yongin-si (KR); Inhyun HWANG, Yongin-si (KR)

(21) Appl. No.: 18/967,927

(22) Filed: Dec. 4, 2024

(30) Foreign Application Priority Data
Jul. 23, 2024 (KR) 10-2024-0097437

(51) Int. Cl. H01M 50/531; H01M 50/103; H01M 50/119; H01M 50/15; H01M 50/528; H01M 50/567; H01M 50/586

(52) U.S. Cl. CPC H01M 50/531; H01M 50/15; H01M 50/528; H01M 50/567; H01M 50/586; H01M 50/103; H01M 50/119

(57) ABSTRACT

A secondary battery includes an electrode assembly, a case accommodating the electrode assembly, a sub-plate connected to the electrode assembly, a current collector comprising a flat portion coupled to the sub-plate and a boss portion protruding from the flat portion, and a first cap assembly coupled to the current collector, wherein the boss portion and the first cap assembly are screw-coupled.

### CROSS-REFERENCE TO RELATED APPLICATION

The present application claims priority to and the benefit of Korean Application No. 10-2024-0097437, filed on Jul. 23, 2024, in the Korean Intellectual Property Office, the entire disclosure of which is incorporated by reference herein.

### BACKGROUND

### 1. Field

Embodiments relate to a secondary battery and a method for manufacturing the same.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

A secondary battery may be classified into a cylindrical secondary battery, a prismatic secondary battery, or a pouch-type secondary battery, depending on the shape of a case. The prismatic secondary battery has a structure in which an electrode assembly is accommodated in a prismatic metal can. The electrode assembly is inserted into the prismatic metal can, and a current collector connected to the electrode assembly is welded to a cap assembly, thereby electrically connecting the electrode assembly to the cap assembly.

The above information disclosed in this Background section is for enhancement of understanding of the background of the present disclosure, and therefore, it may contain information that does not constitute related (or prior) art.

### SUMMARY

Embodiments include a secondary battery, including an electrode assembly, a case accommodating the electrode assembly, a sub-plate connected to the electrode assembly, a current collector comprising a flat portion coupled to the sub-plate and a boss portion protruding from the flat portion, and a first cap assembly coupled to the current collector, wherein the boss portion and the first cap assembly are screw-coupled.

The boss portion may include a first screw coupling portion on an outer circumferential surface thereof, and the first screw coupling portion may be at an end of the boss portion.

The boss portion may protrude from the flat portion by a first length, and the first screw coupling portion may have a second length that is less than or equal to one-third of the first length.

The first screw coupling portion may include two to three screw threads.

The secondary battery may further include an insulator on the flat portion and including a through-hole, wherein the boss portion protrudes through the through-hole.

A lower end of the first screw coupling portion may be positioned higher than an upper end of the insulator in a direction in which the boss portion protrudes.

The first cap assembly may include a cap plate, a terminal plate, and a sealing member insulating the cap plate from the terminal plate, the terminal plate including a second screw coupling portion, corresponding to the first screw coupling portion, including one or more screw grooves on an inner circumferential surface thereof, and the boss portion passes through the cap plate and the sealing member and is screw-coupled to the terminal plate.

The case may include an open first side and an open second side opposite to the open first side, and the first cap assembly may cover the open first side.

The secondary battery may further include a second cap assembly covering the open second side of the case.

The case may include a first long sidewall and a second long sidewall facing each other while being spaced apart from each other, and a first short sidewall and a second short sidewall facing each other while being spaced apart from each other, each of the first short sidewall and the second short sidewall having a smaller area than that of each of the first long sidewall and the second long sidewall.

The case may further include a vent at the first short sidewall or the second short sidewall.

Embodiments include a method for manufacturing a secondary battery, the method including preparing an electrode assembly to which a first current collector and a second current collector are connected, coupling a first cap assembly to the first current collector, inserting the electrode assembly into a case, and coupling a second cap assembly to the second current collector, wherein the first current collector includes a flat portion and a boss portion protruding from the flat portion, and the boss portion and the first cap assembly are screw-coupled.

The boss portion may include a first screw coupling portion on an outer circumferential surface thereof, and the first screw coupling portion may be at an end of the boss portion.

The boss portion may protrudes from the flat portion by a first length, and the first screw coupling portion may have a second length that is less than or equal to one-third of the first length.

The first screw coupling portion may include two to three screw threads.

The method may further include placing an insulator having a through-hole on the flat portion, prior to the coupling of the first cap assembly to the first current collector, wherein the boss portion may protrude through the through-hole.

A lower end of the first screw coupling portion may be positioned higher than an upper end of the insulator in a direction in which the boss portion protrudes.

The first cap assembly may include a cap plate, a terminal plate, and a sealing member insulating the cap plate from the terminal plate, the terminal plate including a second screw coupling portion, corresponding to the first screw coupling portion, including one or more screw grooves on an inner circumferential surface thereof, and the coupling of the first cap assembly to the first current collector may include passing the boss portion through the cap plate and the sealing member, and rotating the first cap assembly such that the first screw coupling portion of the boss portion is screw-coupled with the second screw coupling portion of the terminal plate.

The coupling of the second cap assembly to the second current collector may include coupling the second cap assembly to the second current collector by welding.

The case may include an open first side and an open second side opposite to the open first side, and the method further include coupling the first cap assembly to the case such that the first cap assembly covers the open first side, and coupling the second cap assembly to the case such that the second cap assembly covers the open second side.

These and other aspects and features of the present disclosure will be described in or will be apparent from the following description of embodiments of the present disclosure.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is a perspective view of a secondary battery according to one or more embodiments of the present disclosure;

FIG. 2 is a perspective view of a case according to one or more embodiments of the present disclosure;

FIG. 3 is a cross-sectional view of a secondary battery according to one or more embodiments of the present disclosure;

FIG. 4 illustrates a structure where a first cap assembly and a first current collector are coupled;

FIG. 5 illustrates a structure where a first cap assembly and a first current collector re separated;

FIG. 6 is an enlarged view of a first boss portion of a first current collector;

FIG. 7 illustrates a structure in which a second cap assembly and a second current collector are coupled;

FIGS. 8 to 12 illustrate methods for manufacturing secondary batteries according to one or more embodiments of the present disclosure; and

FIG. 13 is a flowchart illustrating a method for manufacturing a secondary battery according to one or more embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

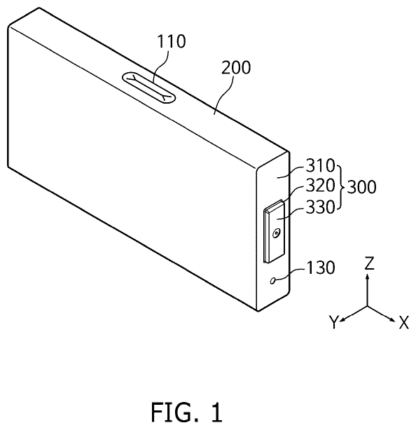

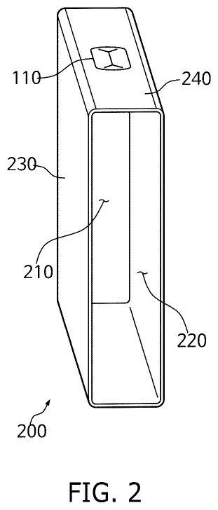

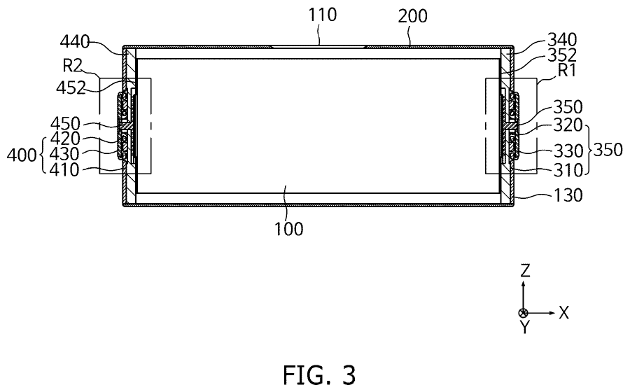

FIG. 1 is a perspective view of a secondary battery according to one or more embodiments of the present disclosure, FIG. 2 is a perspective view of a case 200 according to one or more embodiments of the present disclosure, and FIG. 3 is a cross-sectional view of a secondary battery according to one or more embodiments of the present disclosure.

Referring to FIG. 1, a secondary battery may include an electrode assembly 100, a case 200 accommodating the electrode assembly 100, a first cap assembly 300, and a second cap assembly 400 (see FIG. 3). The first cap assembly 300 may include a first cap plate 310, a first terminal plate 330, and a first sealing member 320 insulating the first cap plate 310 from the first terminal plate 330.

The electrode assembly 100 may be accommodated within the case 200. The electrode assembly 100 may be formed by winding or stacking a stack of a first electrode plates, a separator, and a second electrode plate, which may be formed as thin plates or films. In a case where the electrode assembly 100 is a wound stack, a winding axis may be parallel to a longitudinal direction of the case 200. In other embodiments, the electrode assembly 100 may be of a stack type rather than a winding type, and the present disclosure does not limit the shape of the electrode assembly 100. In addition, the electrode assembly 100 may be a Z-stack electrode assembly in which a positive electrode plate and a negative electrode plate are inserted into both sides of a separator, which is then bent into the Z-stack. Further, the electrode assembly 100 may also include one or more electrode assemblies 100 that are stacked such that long sides of the electrode assemblies are adjacent to each other and accommodated in the case 200, and the present disclosure does not limit the number of electrode assemblies 100. The first electrode plate of the electrode assembly 100 may serve as a positive electrode, and the second electrode plate may serve as a negative electrode. The reverse case may be also possible.

The first electrode plate may be formed by applying a first electrode active material, such as graphite or carbon, onto a first electrode substrate formed of a metal foil, such as copper, a copper alloy, nickel, or a nickel alloy. The first electrode plate may include a first electrode tab (e.g., a first uncoated portion) that is a region onto which the first electrode active material is not applied. The first electrode tab may serve as a current flow path between the first electrode plate and the first cap assembly 300. In one or more embodiments, when the first electrode plate is manufactured, the first electrode tab may be formed by being cut in advance to protrude to one side of the electrode assembly, or the first electrode tab may protrude to one side of the electrode assembly more than (e.g., farther than or beyond) the separator without being separately cut.

The second electrode plate may be formed by applying a second electrode active material, such as a transition metal oxide, onto a second electrode substrate formed of metal foil, such as aluminum or an aluminum alloy. The second electrode plate may include a second electrode tab (e.g., a second uncoated portion) that is a region onto which the second electrode active material is not applied. The second electrode tab may serve as a current flow path between the second electrode plate and the second cap assembly. In one or more embodiments, the second electrode tab may be formed by being cut in advance to protrude to the other side (e.g., the opposite side) of the electrode assembly when the second electrode plate is manufactured, or the second electrode plate may protrude to the other side of the electrode assembly more than (e.g., farther than or beyond) the separator without being separately cut.

In one or more embodiments, an electrolyte injection hole 130 may be formed on the first cap plate 310. An electrolyte may be injected into the case 200 through the electrolyte injection hole 130. In FIG. 1, the electrolyte injection hole 130 is illustrated as being formed on the first cap plate 310, but the present disclosure is not limited thereto. After the injection of the electrolyte is completed, the electrolyte injection hole 130 may be sealed using a sealing means, such as a sealing stopper.

Referring to FIG. 2, the case 200 may include long sidewalls 230 facing each other, short sidewalls 240 facing each other, an open first side 210, and an open second side 220.

A first direction X may refer to the X-axis direction shown in FIG. 1. A second direction Y may be orthogonal to the first direction X. The second direction Y refers to the Y-axis direction. A third direction Z may be orthogonal to each of the first direction X and the second direction Y. The third direction Z refers to the Z-axis direction.

The long sidewalls 230 may include a first long sidewall portion and a second long sidewall portion. The first long sidewall portion and the second long sidewall portion may face each other. The first long sidewall portion and the second long sidewall portion may face each other while being spaced apart from each other in the second direction Y.

The short sidewalls 240 may include a first short sidewall portion and a second short sidewall portion. The first short sidewall portion and the second short sidewall portion may face each other. The first short sidewall portion and the second short sidewall portion may face each other while being spaced apart from each other in the third direction Z. The area of each of the first short sidewall portion and the second short sidewall portion may be smaller than the area of each of the first long sidewall portion and the second long sidewall portion.

The open first side 210 and the open second side 220 may be formed at the opposite sides of the case 200, respectively. The open second side 220 may face the open first side 210. The open second side 220 and the open first side 210 may face each other while being spaced apart from each other in the first direction X. Each of the open first side 210 and the open second side 220 may refer to an open area.

The case 200 may be formed of a conductive metal, such as aluminum, an aluminum alloy, or a nickel-plated steel.

In one or more embodiments, a vent 110 may be formed at one side of the case 200. For example, the vent 110 may be formed at a lower surface of the case 200. Herein, the lower surface of the case 200 may refer to a surface facing downward in a case where the secondary battery is finally installed. The vent 110 may prevent the explosion of the secondary battery or prevent a chain exothermic reaction of neighboring secondary batteries arranged in close proximity to the secondary battery.

In one example, the vent 110 may be configured to open in a case where an internal pressure of the secondary battery exceeds a predetermined threshold pressure. In this case, the threshold pressure may be set differently depending on the application, the material, the purpose, and the like of the secondary battery. In another example, the vent 110 may be configured to open in a case where an internal temperature exceeds a predetermined threshold temperature.

In FIGS. 1 and 2, the vent 110 is illustrated as being a single vent formed at a central portion of one surface of the case 200, but the present disclosure is not limited thereto. Any number of vents 110 may be formed at arbitrary positions at one surface of the case 200. For example, two or more vents 110 may be formed at one surface of the case 200.

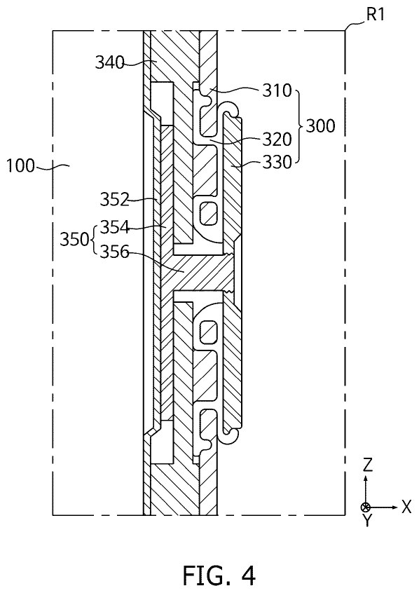

Referring to FIG. 3, the first cap assembly 300 (see FIG. 4) may be coupled to the open first side of the case 200. In one embodiment, the first cap assembly 300 may include the first cap plate 310, the first terminal plate 330, and the first sealing member 320 that insulates the first cap plate 310 from the first terminal plate 330. The first cap plate 310 is arranged to cover the first side of the case 200, and the first cap plate 310 and the case 200 may be coupled by welding.

The second cap assembly 400 may be coupled to the open second side of the case 200. In one embodiment, the second cap assembly 400 may include a second cap plate 410, a second terminal plate 430, and a second sealing member 420 that insulates the second cap plate 410 from the second terminal plate 430. The second cap plate 410 is arranged to cover the second side of the case 200, and the second cap plate 410 and the case 200 may be coupled by welding. The case 200 may be sealed by the first cap assembly 300 and the second cap assembly 400.

The electrode assembly 100 accommodated in the case 200 may be electrically connected to the first cap assembly 300 through a first current collector 350. For example, a first sub-plate 352 and the first current collector 350 coupled to the first sub-plate 352 may be connected to a first side of the electrode assembly 100. The first current collector 350 may be coupled to the first terminal plate 330 of the first cap assembly 300. The first sub-plate 352 and the first current collector 350 may serve as a current flow path through which the electrode assembly 100 is electrically connected to the first terminal plate 330.

In one embodiment, the first current collector 350 and the first terminal plate 330 may be screw-coupled. An example of coupling the first current collector 350 to the first cap assembly 300 will be described in detail with reference to FIGS. 4 to 6.

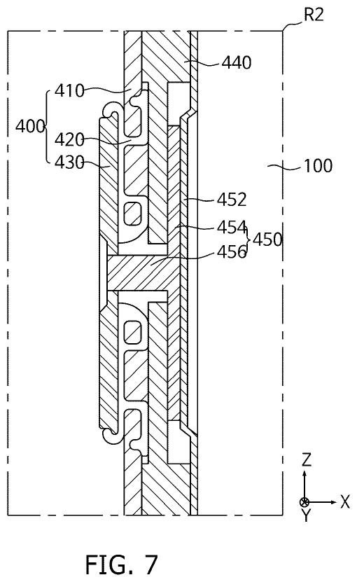

The electrode assembly 100 may be electrically connected to the second cap assembly 400 through a second current collector 450 (see FIG. 7). For example, a second sub-plate 452 and the second current collector 450 coupled to the second sub-plate 452 may be connected to a second side of the electrode assembly, which is opposite to the first side of the electrode assembly 100 to which the first current collector 350 is connected. The second current collector 450 may be coupled to the second terminal plate 430 of the second cap assembly 400. The second sub-plate 452 and the second current collector 450 may serve as a current flow path through which the electrode assembly 100 is electrically connected to the second terminal plate 430.

In one embodiment, the second current collector 450 and the second terminal plate 430 may be coupled by welding. An example of coupling the second current collector 450 to the second cap assembly 400 will be described in detail with reference to FIG. 7.

A first insulator 340 may be disposed between the first current collector 350 and the first cap assembly 300. The first insulator 340 may prevent the first sub-plate 352 and the first cap assembly 300 from coming into contact with each other. Similarly, a second insulator 440 may be disposed between the second current collector 450 and the second cap assembly 400. The second insulator 440 may prevent the second sub-plate 452 and the second cap assembly 400 from coming into contact with each other.

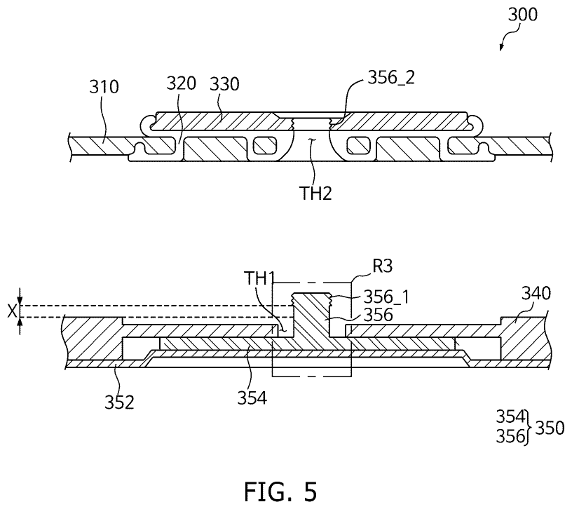

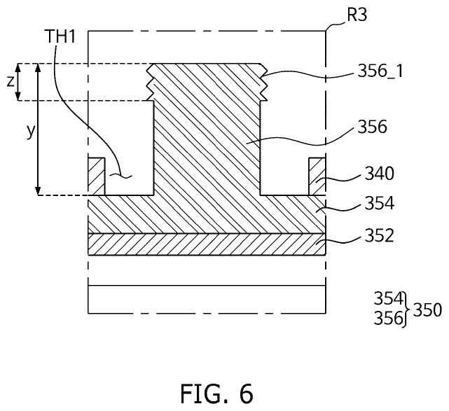

FIG. 4 illustrates a structure where the first cap assembly 300 and the first current collector 350 are coupled, FIG. 5 illustrates a structure where the first cap assembly 300 and the first current collector 350 are separated, and FIG. 6 is an enlarged view of a first boss portion 356 of the first current collector 350. For reference, FIG. 4 is an enlarged view of a region R1 shown in FIG. 3, and FIG. 6 is an enlarged view of a region R3 shown in FIG. 5.

Referring to FIG. 4, the first sub-plate 352 and the first collector 350 are connected to one side of the electrode assembly 100, and the first collector 350 can be coupled with the first cap assembly 300.

The first sub-plate 352 may be coupled to one side of the electrode assembly 100 and may be electrically connected to the first electrode plate (e.g., the negative electrode plate) of the electrode assembly 100. For example, the first electrode tab of the first electrode plate may protrude from one side of the electrode assembly 100, and the first electrode tab may be welded to the first sub-plate 352. The first sub-plate 352 may be electrically connected to the first electrode plate by being in contact with the first electrode tab.

The first sub-plate 352 may be coupled with the first current collector 350. The first current collector 350 may include a first flat portion 354 and a first boss portion 356 protruding from the first flat portion 354. The first sub-plate 352 may be coupled to the first flat portion 354 of the first current collector 350 by welding.

The first boss portion 356 may protrude in the first direction X, which is opposite to the direction facing the electrode assembly 100. The first boss portion 356 may be formed in a substantially cylindrical shape. The first boss portion 356 may instead have various shapes other than a cylindrical shape.

The first insulator 340 may be disposed between the first sub-plate 352 and the first cap assembly 300. An adhesive surface may be formed on a surface where the first insulator 340 and the first sub-plate 352 are in contact with each other, so that the first insulator 340 may be attached to the first sub-plate 352. After being disposed on the first sub-plate 352, the first insulator 340 may be connected with a tape. The first insulator 340 may prevent the first sub-plate 352 and the first cap plate 310 from coming into contact with each other.

At least a portion of the first insulator 340 may extend to be disposed on the first flat portion 354 of the first current collector 350. As the first insulator 340 extends and its area increases, the rigidity of the first insulator 340 is enhanced, preventing deformation and allowing the first insulator 340 to be securely seated on the first sub-plate 352.

The first insulator 340 may include a through-hole. The first boss portion 356 of the first current collector 350 may protrude through the through-hole of the first insulator 340. The first boss portion 356, protruding through the through-hole, may be coupled with the first cap assembly 300. The first boss portion 356 of the first current collector 350 and the first cap assembly 300 may be screw-coupled. An example of the screw coupling between the first current collector 350 and the first cap assembly 300 will be described in detail with reference to FIG. 5.

The first cap assembly 300 may include the first cap plate 310, the first sealing member 320, and the first terminal plate 330. The first sealing member 320 may seal the space between the first terminal plate 330 and the first cap plate 310. The first sealing member 320 may include an insulating material. The first cap plate 310 and the first terminal plate 330 may be insulated from each other by the first sealing member 320.

The first terminal plate 330 may be coupled to the first sealing member 320. The first terminal plate 330 may serve as the negative electrode terminal of the secondary battery. For example, a busbar may be welded onto the first terminal plate 330, allowing multiple secondary batteries to be electrically connected.

Referring to FIG. 5, the first current collector 350 may include a first screw coupling portion 356_1 for coupling with the first cap assembly 300. The first screw coupling portion 356_1 may be formed on an outer circumferential surface of the first boss portion 356 of the first current collector 350. For example, the first screw coupling portion 356_1 may be formed on an outer circumferential surface of a side surface of the first boss portion 356.

The first cap assembly 300 may include a second screw coupling portion 356_2 for coupling with the first current collector 350. For example, each of the first cap plate 310 and the first sealing member 320 may have a through-hole TH2 through which the first boss portion 356 of the first current collector 350 passes. The first terminal plate 330 may include a screw groove formed on an inner circumferential surface thereof, which corresponds to the first screw coupling portion 356_1.

The first current collector 360 and the first cap assembly 300 may be screw-coupled. For example, the first boss portion 356 may be arranged to pass through the through-holes TH2 of the first cap plate 310 and the first sealing member 320. Additionally, the first screw coupling portion 356_1 of the first boss portion 356 may be positioned to correspond (e.g., positioned to align) with the second screw coupling portion 356_2 of the first terminal plate 330. By rotating the first cap assembly 300, the first screw coupling portion 356_1 of the first boss portion 356 and the second screw coupling portion 356_2 of the first terminal plate 330 can be screw-coupled. Alternatively, by rotating the first boss portion 356 and the structure connected thereto, the first screw coupling portion 356_1 of the first boss portion 356 and the second screw coupling portion 356_2 of the first terminal plate 330 can be screw-coupled.

Referring to FIGS. 5 and 6, the first screw coupling portion 356_1 may be positioned at an end of the first boss portion 356. Specifically, based on a direction in which the first boss portion 356 protrudes through a through-hole TH1 of the first insulator 340, a lower end of the first screw coupling portion 356_1 (e.g., an end of the screw groove facing the through-hole TH1) may be positioned higher than an upper end of the first insulator 340 (e.g., relative to the first sub-plate 352). By maintaining a separation of a predetermined length (see ‘X’ in FIG. 5) or more between the first screw coupling portion 356_1 and the first insulator 340, the first cap assembly 300 may not interfere with the first insulator 340 during the process of screw coupling with the first boss portion 356.

Additionally, the first screw coupling portion 356_1 may be formed to be less than or equal to one-third of the total length of the first boss portion 356. For example, the first screw coupling portion 356_1 of the first boss portion 356 may protrude by a first length (y) from the first flat portion 354 of the first current collector 350, and the first screw coupling portion 356_1 may be formed with a second length (z) that is less than or equal to one-third of the first length (y).

The first screw coupling portion 356_1 may include a plurality of screw threads. In a case where the first screw coupling portion 356_1 includes less than a certain number of screw threads, the coupling force between the first current collector 350 and the first cap assembly 300 may not be sufficiently secured. Conversely, in a case where the first screw coupling portion 356_1 includes more than a certain number of screw threads, the coupling length between the first cap assembly 300 and the first current collector 350 may increase, causing the first cap assembly 300 to interfere with the first insulator 340. Accordingly, the first screw coupling portion 356_1 may preferably include 2 to 3 screw threads, but is not limited thereto. The number of screw threads may be appropriately changed in consideration of factors such as a pitch of the screw threads, a thickness of the first boss portion 356, and the like.

With this configuration, as the first current collector 350 and the first cap assembly 300 are screw-coupled, a certain level of coupling force can be secured between the first current collector 350 and the first cap assembly 300 until the first cap assembly 300 is welded to the case.

Further, as the first current collector 350 and the first cap assembly 300 are screw-coupled, the welding process between the first current collector 350 and the first cap assembly 300 may be omitted. As a result, the welding residue from the welding of the first current collector 350 and the first cap assembly 300 can be essentially prevented from entering the inside of the case.

FIG. 7 illustrates a structure in which the second cap assembly 400 and the second current collector 450 are coupled. For reference, FIG. 7 is an enlarged view of a region R2 shown in FIG. 3. For the sake of convenience in explanation, the description will focus on points that are different from those described in FIGS. 4 to 6.

The other side of the electrode assembly 100 (e.g., the side opposite to the side of the electrode assembly to which the first sub-plate is coupled) may be connected to the second sub-plate 452 and the second current collector 450. The second current collector 450 may be coupled with the second cap assembly 400.

The second sub-plate 452 is coupled to the other side of the electrode assembly 100 and may be electrically connected to the second electrode plate (e.g., the positive electrode plate) of the electrode assembly 100. For example, the second electrode tab of the second electrode plate may protrude from the other side of the electrode assembly 100, and the second electrode tab may be welded to the second sub-plate 452. The second sub-plate 452 may be electrically connected to the second electrode plate by being in contact with the second electrode tab.

The second sub-plate 452 may be coupled with the second current collector 450. The second current collector 450 may include a second flat portion 454 and a second boss portion 456 protruding from the second flat portion 454. The second sub-plate 452 may be coupled to the second flat portion 454 of the second current collector 450 by welding.

The second insulator 440 may be disposed between the second sub-plate 452 and the second cap assembly 400. The second insulator 440 may prevent the second sub-plate 452 and the second cap plate 410 from coming into contact with each other.

The second insulator 440 may include a through-hole. The second boss portion 456 of the second current collector 450 may protrude through the through-hole of the second insulator 440. The second boss portion 456, protruding through the through-hole, may be coupled with the second cap assembly 400. The second boss portion 456 of the second current collector 450 and the second cap assembly 400 may be coupled by welding.

In other words, the first current collector connected to the negative electrode plate, which is relatively vulnerable to welding defects, is screw-coupled together with the first cap assembly, thereby eliminating the need for the welding process, and the second current collector 450 connected to the positive electrode plate may be welded together with the second cap assembly 400. This configuration improves the quality of the secondary battery while ensuring efficiency and ease of the manufacturing process.

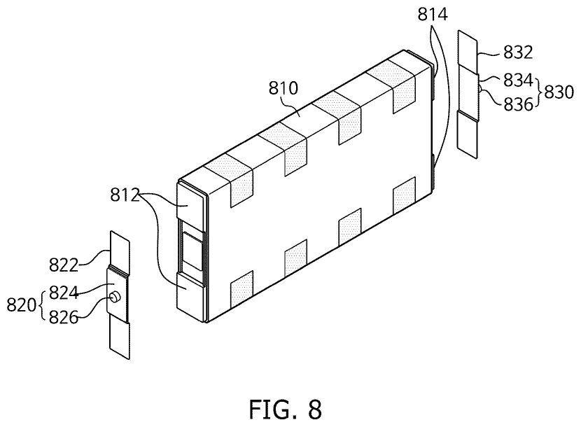

FIGS. 8 to 12 illustrate methods for manufacturing secondary batteries according to one or more embodiments of the present disclosure.

Referring to FIG. 8, an electrode assembly 810 may be connected to a first sub-plate 822. For example, on one side of the electrode assembly 810, a first electrode tab 812 connected to a first electrode plate (e.g., a negative electrode plate) protrudes, and the first electrode tab 812 may be welded to the first sub-plate 822.

The first current collector 820, which is coupled with the first sub-plate 822, may be electrically connected to the electrode assembly 810 through the first sub-plate 822. The first current collector 820 may include a first flat portion 824 connected to the first sub-plate 822 and a first boss portion 826 protruding from the first flat portion 824.

Similarly, the electrode assembly 810 may be connected to a second sub-plate 832. On the other side (the opposite side) of the electrode assembly 810, a second electrode tab 814 connected to a second electrode plate (e.g., a positive electrode plate) protrudes, and the second electrode tab 814 may be welded to the second sub-plate 832.

The second current collector 830, which is connected to the second sub-plate 832, may be electrically connected to the electrode assembly 810 through the second sub-plate 832. The second current collector 830 may include a second flat portion 834 connected to the second sub-plate 832 and a second boss portion 836 protruding from the second flat portion 834.

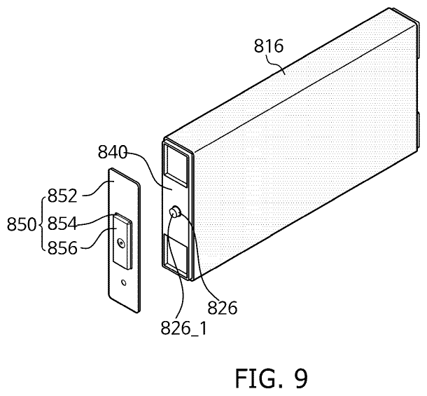

Referring to FIG. 9, a first insulator 840 may be disposed on the first current collector connected to the electrode assembly. The first insulator 840 is positioned on a planar portion (surface) of the first sub-plate and the first current collector, preventing the first sub-plate from coming into contact with a first cap assembly 850.

The first insulator 840 may include a through-hole through which the first boss portion 826 of the first current collector passes. The first boss portion 826 may protrude through the through-hole when the first insulator 840 is in place.

Similarly, the second insulator may be disposed on the second current collector connected to the electrode assembly, and the second insulator can prevent the second sub-plate from coming into contact with the second cap assembly. Additionally, the second boss portion of the second current collector may protrude through a through-hole in the second insulator.

A protective tape 816 may be attached to the sides of the electrode assembly. For example, the protective tape 816 may be attached along the circumferential surface of the electrode assembly where the first insulator 840 and the second insulator are not disposed. The protective tape 816 may serve to electrically insulate the electrode assembly from the case.

The first cap assembly 850 may be coupled with the first current collector. Specifically, the first boss portion 826 of the first current collector may be coupled with the first cap assembly 850. The first boss portion 826 may include a first screw coupling portion 826_1 at an end thereof. The first cap assembly 850 may include a first cap plate 852, a first sealing member 854, and a first terminal plate 856. The first terminal plate 856 may include a second screw coupling portion corresponding to (e.g., coupling with) the first screw coupling portion 826_1.

In one embodiment, the first screw coupling portion 826_1 of the first boss portion 826 may include a plurality of screw threads, and the second screw coupling portion of the first terminal plate 856 may include a plurality of screw grooves corresponding to the first screw coupling portion 826_1. The first boss portion 826 may be arranged to pass through the first cap plate 852 and the first sealing member 854 and positioned to correspond to the second screw coupling portion of the first terminal plate 856. Subsequently, by rotating the first cap assembly 850, the first screw coupling portion 826_1 of the first boss portion 826 may be screw-coupled with the second screw coupling portion of the first terminal plate 856. Thus, a coupling force (secure connection) between the first cap assembly 850 and the electrode assembly can be maintained until the first cap assembly 850 is coupled with the case. Alternatively, instead of rotating the first cap assembly 850, the first boss portion 826 and the structure connected thereto may be rotated to advance the screw-coupling.

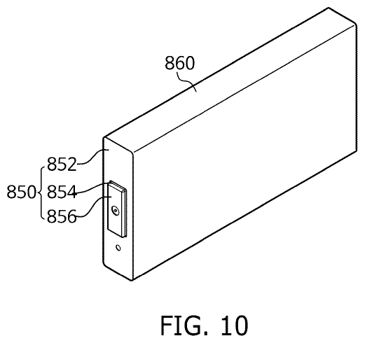

Referring to FIG. 10, the electrode assembly to which the first cap assembly 850 is coupled may be inserted into a case 860. The case 860 may include an open first side and an open second side. The first cap assembly 850 may be arranged to cover the open first side of the case 860.

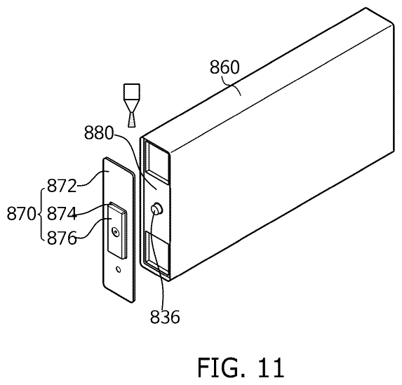

Referring to FIG. 11, after the electrode assembly is inserted into the case 860, a second cap assembly 870 and the second current collector may be coupled. For example, the second cap assembly 870 may include a second cap plate 872, a second sealing member 874, and a second terminal plate 876. The second boss portion 836 of the second current collector may protrude through a through-hole of a second insulator 880 and may be coupled with the second terminal plate 876.

The second boss portion 836 and the second cap assembly 870 may be coupled while the electrode assembly is inserted into the case 860. To this end, the second boss portion 836 and the second terminal plate 876 may be coupled by welding, but the coupling method is not limited thereto. The second cap assembly 870 may be arranged to cover the open second side of the case 860.

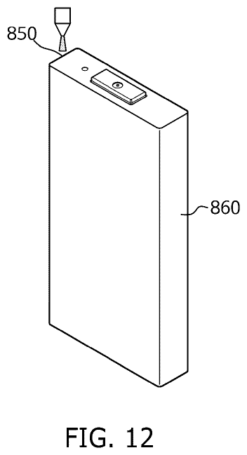

Referring to FIG. 12, the first cap assembly 850 may be coupled with the case 860. Specifically, the first cap assembly 850 is arranged to cover the open first side of the case 860, and the first cap assembly 850 is welded to the case 860 around a periphery thereof, thereby sealing the open first side of the case 860.

The second cap assembly may be coupled with the case. Specifically, the second cap assembly may be arranged to cover the open second side of the case, and the second cap assembly may be welded to the case similar to FIG. 12, thereby sealing the open second side of the case.

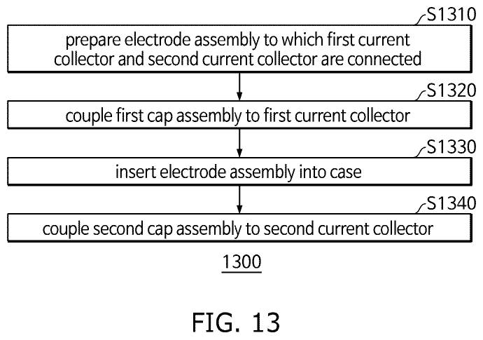

FIG. 13 is a flowchart illustrating a method 1300 for manufacturing a secondary battery according to one or more embodiments of the present disclosure. The method 1300 for manufacturing the secondary battery may begin with preparing an electrode assembly to which a first current collector and a second current collector are connected (step S1310). The first current collector may include a flat portion and a boss portion protruding from the flat portion.

In one embodiment, the boss portion may protrude from the flat portion by a first length, and a first screw coupling portion may be formed with a second length that is less than or equal to one-third of the first length. Additionally or alternatively, the first screw coupling portion may include 2 to 3 screw threads.

Thereafter, an insulator having a through-hole may be arranged on the flat portion of the first current collector. The boss portion may protrude through the through-hole of the insulator. Based on a direction in which the boss portion protrudes, a lower end of the first screw coupling portion may be positioned higher than an upper end of the insulator.

Subsequently, a first cap assembly may be coupled to the first current collector (step S1320). The boss portion of the first current collector may include the first screw coupling portion on an outer circumferential surface thereof, and the first screw coupling portion may be formed at an end of the boss portion. The first cap assembly may include a cap plate, a terminal plate, and a sealing member that insulates the cap plate from the terminal plate, and the terminal plate may include a second screw coupling portion that includes screw grooves formed on an inner circumferential surface of the terminal plate. The second screw coupling portion may be formed to correspond to the first screw engagement portion.

Accordingly, the first cap assembly and the first current collector may be screw-coupled. Specifically, the first cap assembly may be arranged on the first current collector such that the boss portion of the first current collector passes through the cap plate and the sealing member. Thereafter, by rotating the first cap assembly, the first screw coupling portion of the boss portion and the second screw coupling portion of the terminal plate may be screw-coupled.

Next, the electrode assembly may be inserted into a case (step S1330). The case may include an open first side and an open second side opposite to the first side. At this time, the first cap assembly may be coupled to the case to cover the open first side of the case.

Next, a second cap assembly may be coupled to the second current collector (step S1340). The second cap assembly may be coupled to the second current collector by welding, but is not limited thereto. The second cap assembly may be coupled to the case to cover the open second side of the case.

The flowchart and the above description of FIG. 13 is merely an example of embodiments of the present disclosure, and the scope of the present disclosure is not limited thereto. For example, one or more processes in the flowchart and the above description may be added, altered, or deleted. The sequence of one or more processes may be changed, and one or more processes may be performed simultaneously.

By way of summation and review, in a case where welding residues from the welding of the current collector and the cap assembly are introduced into the case, the quality of the secondary battery may deteriorate.

According to one or more embodiments of the present disclosure, the welding process between the first current collector and the first cap assembly can be omitted as the first current collector and the first cap assembly are screw-coupled. As a result, the welding residue from the welding of the first current collector and the first cap assembly can be essentially prevented from entering the inside of the case.

According to one or more embodiments of the present disclosure, the first current collector connected to the negative electrode plate, which is relatively susceptible to poor welds, is screw-coupled together with the first cap assembly, thereby eliminating the need for the welding process, and the second current collector 450 connected to the positive electrode plate may be welded together with the second cap assembly 400. This configuration improves the quality of the secondary battery while ensuring efficiency and ease of the manufacturing process.

According to one or more embodiments of the present disclosure, by forming the first screw coupling portion at the end of the first boss portion, a sufficient level of coupling force between the first cap assembly and the first current collector can be maintained until the first cap assembly is welded to the case without the first cap assembly interfering with the first insulator.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated.

Accordingly, it will be understood by those of skill in the art that various changes in form and details may be made without departing from the spirit and scope of the present invention as set forth in the following claims.

### DESCRIPTION OF SOME REFERENCE SYMBOLS

100: electrode assembly
130: electrolyte injection hole
200: case
300: first cap assembly
310: first cap plate
320: first sealing member
330: first terminal plate

What is claimed is:

1. A secondary battery, comprising:
an electrode assembly;
a case accommodating the electrode assembly;
a sub-plate connected to the electrode assembly;
a current collector comprising a flat portion coupled to the sub-plate and a boss portion protruding from the flat portion; and
a first cap assembly coupled to the current collector,
wherein the boss portion and the first cap assembly are screw-coupled.

2. The secondary battery as claimed in claim 1, wherein:
the boss portion comprises a first screw coupling portion on an outer circumferential surface thereof, and
the first screw coupling portion is at an end of the boss portion.

3. The secondary battery as claimed in claim 2, wherein:
the boss portion protrudes from the flat portion by a first length, and
the first screw coupling portion has a second length that is less than or equal to one-third of the first length.

4. The secondary battery as claimed in claim 2, wherein the first screw coupling portion comprises two to three screw threads.

5. The secondary battery as claimed in claim 2, further comprising an insulator on the flat portion and including a through-hole, wherein the boss portion protrudes through the through-hole.

6. The secondary battery as claimed in claim 5, wherein a lower end of the first screw coupling portion is positioned higher than an upper end of the insulator in a direction in which the boss portion protrudes.

7. The secondary battery as claimed in claim 2, wherein:
the first cap assembly comprises a cap plate, a terminal plate, and a sealing member insulating the cap plate from the terminal plate,
the terminal plate comprises a second screw coupling portion, corresponding to the first screw coupling portion, including one or more screw grooves on an inner circumferential surface thereof, and
the boss portion passes through the cap plate and the sealing member and is screw-coupled to the terminal plate.

8. The secondary battery as claimed in claim 1, wherein the case comprises an open first side and an open second side opposite to the open first side, and the first cap assembly covers the open first side.

9. The secondary battery as claimed in claim 8, further comprising a second cap assembly covering the open second side of the case.

10. The secondary battery as claimed in claim 9, wherein the case comprises:
a first long sidewall and a second long sidewall facing each other while being spaced apart from each other; and
a first short sidewall and a second short sidewall facing each other while being spaced apart from each other, each of the first short sidewall and the second short sidewall having a smaller area than that of each of the first long sidewall and the second long sidewall.

11. The secondary battery as claimed in claim 10, wherein the case further comprises a vent at the first short sidewall or the second short sidewall.

12. A method for manufacturing a secondary battery, the method comprising:
preparing an electrode assembly to which a first current collector and a second current collector are connected;
coupling a first cap assembly to the first current collector;
inserting the electrode assembly into a case; and
coupling a second cap assembly to the second current collector, wherein:
the first current collector comprises a flat portion and a boss portion protruding from the flat portion, and
and the boss portion and the first cap assembly are screw-coupled.

13. The method as claimed in claim 12, wherein:
the boss portion comprises a first screw coupling portion on an outer circumferential surface thereof, and
the first screw coupling portion is at an end of the boss portion.

14. The method as claimed in claim 13, wherein:
the boss portion protrudes from the flat portion by a first length, and
the first screw coupling portion has a second length that is less than or equal to one-third of the first length.

15. The method as claimed in claim 13, wherein the first screw coupling portion comprises two to three screw threads.

16. The method as claimed in claim 13, further comprising placing an insulator having a through-hole on the flat portion, prior to the coupling of the first cap assembly to the first current collector, wherein the boss portion protrudes through the through-hole.

17. The method as claimed in claim 16, wherein a lower end of the first screw coupling portion is positioned higher than an upper end of the insulator in a direction in which the boss portion protrudes.

18. The method as claimed in claim 13, wherein:
the first cap assembly comprises a cap plate, a terminal plate, and a sealing member insulating the cap plate from the terminal plate,
the terminal plate comprises a second screw coupling portion, corresponding to the first screw coupling portion, including one or more screw grooves on an inner circumferential surface thereof, and
the coupling of the first cap assembly to the first current collector comprises:
passing the boss portion through the cap plate and the sealing member; and
rotating the first cap assembly such that the first screw coupling portion of the boss portion is screw-coupled with the second screw coupling portion of the terminal plate.

19. The method as claimed in claim 12, wherein the coupling of the second cap assembly to the second current collector comprises:
coupling the second cap assembly to the second current collector by welding.

20. The method as claimed in claim 13, wherein the case comprises an open first side and an open second side opposite to the open first side, the method further comprising:
coupling the first cap assembly to the case such that the first cap assembly covers the open first side; and
coupling the second cap assembly to the case such that the second cap assembly covers the open second side.
